(19) United States
(12) Patent Application Publication
(10) Pub. No.: US 2010/0010900 A1
(43) Pub. Date: Jan. 14, 2010

(54) SYSTEM AND METHOD OF INTERACTIVE AREA ADVERTISEMENT USING MULTICAST TRANSMITTING

(76) Inventors: Sang Hyeun Lee, Gwangju (KR); Seung Hun Oh, Gwangju (KR); Byung Tak Lee, Gyeonggi-do (KR); Sung Yong Lee, Gwangju (KR); Ho Young Song, Daejeon (KR); Bong Tae Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/518,261

(22) PCT Filed: Oct. 16, 2007
(86) PCT No.: PCT/KR07/05052

§ 371 Date: Jun. 8, 2009

(30) Foreign Application Priority Data
Dec. 8, 2006 (KR) 10-2006-0124887

(51) Int. Cl. G06Q 30/00

(52) U.S. Cl. 705/14.69; 705/14.4

(57) ABSTRACT

An interactive advertisement system and a method thereof are provided. The interactive advertisement system includes an advertiser server, a local advertisement server, and a service receiver. The advertiser server requests registration of advertisement information by setting advertisement ID including target service areas and provides services in response to an order of available services corresponding to the advertisement information. The local advertisement server stores and registers the advertisement information including the advertisement ID corresponding to the registration request of the advertiser server, multicasts the registered advertisement information with the advertisement ID through an IP network, and transmits information related to a service request to the advertiser server. The service receiver extracts advertisement information providing a corresponding service from the received advertisement information, outputs the extracted information through a user interface, requesting the local advertisement server to order the input service, and receives the corresponding service from the advertiser server.

### TECHNICAL FIELD

The present invention relates to an interactive area advertisement system and a method thereof and, more particularly, to an interactive area advertisement system and a method thereof for providing an advertisement service that allows a user to order products or services through advertisements using a service receiver such as an IP set-top box or a personal computer.

### BACKGROUND ART

According to the development of the Internet, the Internet has been used not only for searching information but also for communicating with others. A network bandwidth is a passage of providing various services in the Internet. Such a network bandwidth has been widened more than 100 Mbps in an access network as well as the Internet back-born network. Therefore, various services including IP Television (IP TV) and video on demand (VoD) have been provided through the internet protocol (IP) network.

The increment of services provided through the Internet also increases the quantity and the variety of advertisements exposed to users. Therefore, various methods for extracting advertisements suitable to a predetermined user from numerous advertisements and outputs the extracted advertisements only to a user have been demanded.

Since a zip code is closely related to a location of a user, a method of extracting advertisements related to a predetermined area was introduced.

In Korea Patent Publication No. 2005-0004303 filled on Jan. 12 2005 (hereinafter, a patent 303), a method for hierarchically extracts local information transferred in a broadcasting form was disclosed. The patent 303 teaches a method of effectively extracting information related to a user requiring the local information transferred in the broadcasting form.

In Korea Patent Publication No. 1999-0078708 filled on Nov. 5, 1999 (hereinafter, a patent 708), a method for providing information related to a zip code and an information classification code inputted from a user after identifying an area suitable to information by a zip code and assigning a code to classify information for inputting information to an information providing system was disclosed.

In the patent 303, information transferred in a broadcasting form is hierarchically shown to a user using a zip code. In the patent 708, information is provided to a user by receiving a zip code and an information classification code. These patents 303 and 708 are not suitable to extract a desired advertisement from advertisements multicasted through an IP network.

### DISCLOSURE OF INVENTION

### Technical Problem

An aspect of the present invention is to provide an advertisement system and method thereof for extracting predetermined information from multicasted advertisement information.

Another aspect of the present invention is to provide an advertisement system and method thereof for requesting predetermined services using interactive communication between a user and an advertiser who provides a service corresponding to a predetermined advertisement, and for providing related services thereof.

A further aspect of the present invention is to provide an advertisement system and a method thereof for providing advertisements by non-hierarchically setting target areas for transmitting advertisement when registering advertisements to provide to a user.

### Technical Solution

According to an aspect of the invention, the invention provides an interactive advertisement system using multicast including: an advertiser server for requesting registration of advertisement information by setting advertisement ID (identification) including areas to provide the advertisement information, and providing services in response to an order of available services corresponding to the advertisement information; a local advertisement server for storing and registering the advertisement information including the advertisement ID corresponding to the registration request of the advertiser server, multicasting the registered advertisement information with the advertisement ID through an IP network, and transmitting information related to an order of requesting services corresponding to the advertisement information to the advertiser server if the services corresponding to the advertisement information are ordered; and a service receiver for receiving the multicasted advertisement information, extracting advertisement information providing a corresponding service from the received advertisement information, and outputting the extracted advertisement information through a user interface, and for requesting the local advertisement server to order the input service if an order of a service corresponding to the outputted advertisement information inputs, and receiving the corresponding service from the advertiser server.

The advertiser server may request the advertisement information to register to the local advertisement server by dividing the advertisement information by a detail level of information that describes the advertisement information.

The advertiser server may request the advertisement information to register to the local advertisement server by dividing the advertisement information into first advertisement and second advertisement by detail level of information describing the advertisement information.

The advertiser server may set non-hierarchically areas to provide the advertisement information.

The advertisement ID may include a national code and an area code for providing the advertisement information, a business category code, an advertisement object code, and mask-bit information for the advertisement information.

The local advertisement server may register and manage the advertisement with the advertisement ID by dividing the advertisement information into the first advertisement information and the second advertisement information, transmit the first advertisement information through multicasting, and transmit the second advertisement information as a web form to the service receiver if the second advertisement corresponding to the first advertisement is requested.

A service related to the second advertisement information may be ordered from the service receiver, and the local advertisement server may store input order information and transmit the input order information to the advertiser server.

The service receiver may set an address ID (identification) including a national code and a local code for receiving a corresponding service by accessing the local advertisement server, and the service receiver may receive the multicasted first advertisement information, and extracts advertisement information providing a corresponding service from the received first advertisement information by comparing the advertisement ID included in the received first advertisement information and the address ID of the service receiver.

The service receiver may output advertisement information extracted from the first advertisement information on the user interface as a subtitle form at a predetermined time interval.

The service receiver may transform a national code and an area code in the advertisement ID of the received first advertisement information to a predetermined length of a binary number, obtain a result A by performing an AND operation with a mask-bit, transform an address ID of the service receiver into a predetermined length of a binary number, obtain a result B by performing an AND operation with the mask-bit of the advertisement ID, and extract advertisement information providing a corresponding service from the first advertisement information by comparing the results A and B.

The service receiver may request second advertisement information set corresponding to the first advertisement information to the local advertisement server based on advertisement object code information included in the advertisement ID in the first advertisement information.

According to another aspect of the invention, the invention provides a method for interactive advertising using multicast including: at a local advertisement server, setting an advertisement ID (identification) including areas to provide advertisement information, and storing and registering the advertisement information including the advertisement ID in response to a registration request when registration of the advertisement information is required; at the local advertisement server, multicasting the registered advertisement information with the advertisement ID; at a service receiver, receiving the multicasted advertisement information, extracting advertisement information providing a corresponding service from the received advertisement information, and outputting the extracted advertisement information through a user interface; and at the service receiver, requesting a service to order when an order of the service corresponding to the outputted advertisement information inputs, and receiving a corresponding thereof.

The step of registering the advertisement information may include: at the local advertisement server, non-hierarchically setting areas to provide the advertisement according to a request instruction; and registering the advertisement information by dividing the advertisement information into first advertisement information and second advertisement information according to a detail level of information describing the advertisement information according to requested instruction.

The advertisement ID may include a national code and an area code to provide the advertisement information, a business category code, an advertisement object code, and mask-bit information for the advertisement information.

The step of multicasting the registered advertisement information may include: multicasting the first advertisement information of the advertisement information through an IP network; and transmitting second advertisement information in a web type to the service receiver when the second advertisement information corresponding to the first advertisement information.

The service receiver may include setting an address ID (identification) including a national code and an area code to provide a corresponding service by accessing the local advertisement server; receiving the multicasted first advertisement information, and extracting advertisement information providing a corresponding service from the received first advertisement information by comparing an advertisement ID included in the first advertisement information and an address ID of the service receiver; outputting the extracted advertisement information from the first advertisement information at a predetermined time interval in a subtitle type; requesting second advertisement information to the local advertisement server if the second advertisement information corresponding to the outputted first advertisement information; and receiving the requested second advertisement information and outputting the received second advertisement information through the user interface.

The step of extracting the advertisement information may include: transforming a national code and an area code of the advertisement ID of the received first advertisement information to a predetermined length of a binary number, and obtaining a result A by performing an “AND” operation with a mask-bit; transforming an address ID of the service receiver into a predetermined length of a binary number, and obtaining a result B by performing an “AND” operation with the mask-bit of the advertisement ID; comparing the result A and the result B whether the results A and B are matched or not; and extracting advertisement information providing a corresponding service from the received first advertisement information if the result A is matched with the result B.

### ADVANTAGEOUS EFFECTS

According to the certain embodiments of the present invention, the advertiser is allowed to select areas to provide advertisements and to provide only advertisements suitable to a user while sustaining advantages of broadcasting advertisement. Therefore, the advertisement efficiency can be maximized, and the convenience can be provided to a user for requesting a service.

According to the certain embodiments of the present invention, an advertiser is allowed to non-hierarchically select advertisement areas. For example, the advertiser can select entire areas or a predetermined area only for providing related advertisement. Therefore, the usability thereof is very high. Furthermore, without interrupting services such as IP TV or VoD, advertisements can be provided to a user according to the present invention. Therefore, a user is allowed to buy products or services through IP s interactivity without using additional communicating devices such as telephone while watching advertisements.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating an interactive local advertisement system using multicast for providing an interactive local advertisement according to an embodiment of the present invention;

FIG. 2 is a block diagram illustrating an advertisement manager 120 of a local advertisement server 100 shown in FIG. 1;

FIG. 3 is a block diagram illustrating an order manager 160 of a local advertisement server 100 shown in FIG. 1;

FIG. 4 is a block diagram illustrating an advertisement processor 320 of a service receiver 300 shown in FIG. 1;

FIG. 5 is a block diagram illustrating an order processor 360 of a service receiver 300 shown in FIG. 1;

FIG. 6 is a flowchart illustrating a method of providing interactive local advertisement using multicast according to an embodiment of the present invention;

FIG. 7 is a view for non-hierarchically selecting areas to provide registered advertisement through an advertiser server 500 according to an embodiment of the present invention;

FIG. 8 is a view illustrating advertisement identification (ID) set by a local advertisement server 100 and address identification (ID) set by a service receiver 300 according to an embodiment of the present invention;

FIG. 9 is a view illustrating first advertisement contents transmitted through multicasting from a local advertisement server 100 shown in FIG. 1;

FIG. 10 is a flowchart illustrating the step S150 for extracting available advertisements to output based on the received advertisement in FIG. 6;

FIG. 11 is a view illustrating a display of a user interface with first advertisement information provided in a subtitle form according to an embodiment of the present invention; and

FIG. 12 is a view illustrating second advertisement information received from the local advertisement server 100 displayed on a user s display in a web form according to an embodiment of the present invention.

### BEST MODE FOR CARRYING OUT THE INVENTION

Hereinafter, preferred embodiments of the present invention will be described in detail with reference to the attached drawings.

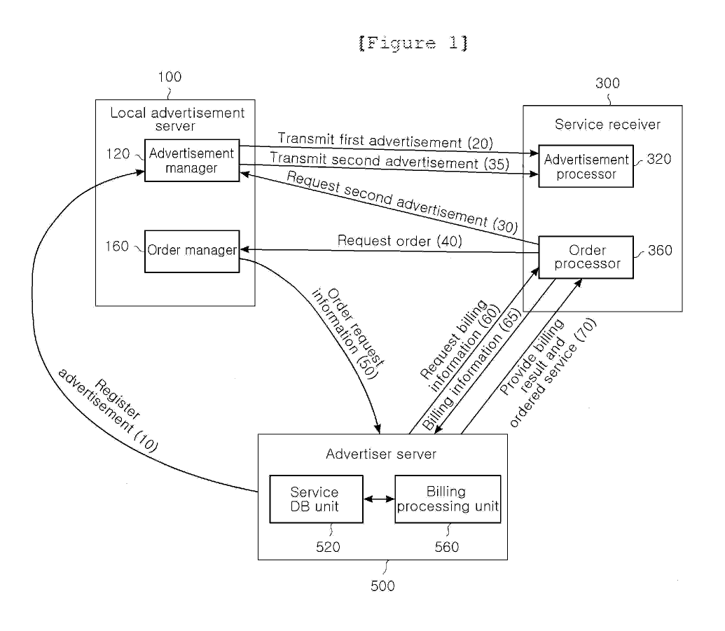

FIG. 1 is a block diagram illustrating an interactive local advertisement system using multicast for providing an interactive local advertisement according to an embodiment of the present invention.

As shown in FIG. 1, the interactive local advertisement system according to the present embodiment includes a local advertisement server 100 for managing and multicasting registered or requested advertisements, a service receiver 300 for receiving the multicasted advertisements, outputting the received advertisements, requesting a service to the local advertisement server 100, and receiving corresponding services, and an advertiser server 500 for registering advertisement information to the local advertisement server 100 with information about an object to provide the advertisement and providing services corresponding to requests to the service receiver 300.

The advertiser server 500 includes a service database 520 for storing registered services to provide corresponding advertisement information, and a billing processor 560 for performing a billing process for charging a related user for providing services requested from the service receiver 300.

The advertiser server 500 accesses the local advertisement server 100 through web and registers a first advertisement including basic contents for services and a second advertisement including detail contents for the same services. Herein, the advertiser server 500 sets and registers areas to transmit a corresponding advertisement at step S10. In the present embodiment, the first advertisement is simple and brief advertisement information outputted in a subtitle form. The second advertisement is detail information about the first advertisement, and provided in web forms such as texts, images, or videos.

The local advertisement server 100 includes an advertisement manager 120 for registering and managing advertisements requested from the advertiser server 500 and transmitting the registered advertisement to the service receiver 300, and an order manager 160 for managing order information requested corresponding to a provided advertisement and transmitting the order information to the advertiser server 500.

When the advertiser server 500 requests the registration of advertisement, the advertisement manager 120 creates an advertisement identification (ID) including advertisement object codes such as a national code, a area code, and an advertisement type code, which are corresponding to an advertisement area selected by the advertiser server 500. The advertisement manager 120 extracts the first advertisement from a registered advertisement database and multicasts the extracted first advertisement to the IP network at step S20.

Herein, the advertisement object code is basic information used when the second advertisement information is requested corresponding to the first advertisement information based on the advertisement object code including the advertisement identification of the first advertisement information.

Meanwhile, the service receiver 300 receiving the first advertisement information transmitted through the IP network includes an advertisement processor 320 for selectively outputting received advertisement information to a user, and an order processor 360 for performing a post process related to information requested to order through the outputted advertisement information. The service receiver 300 according to the present embodiment is a device capable of receiving various IP services such as IP TV, or VoD by accessing an IP network through wired or wireless links. For example, the service receiver 300 may be an IP set-top box, a personal computer (PC), or a mobile device.

The advertisement processor 320 compares an address ID (identification information) set to the service receiver 300 with the advertisement ID (identification information) of the received advertisement information, extracts advertisement only related to a corresponding area from the received advertisement information, stores the extracted advertisement, and displays it to the user as a subtitle type.

When a user selects one of the first advertisements, the order processor 360 requests the related second advertisement to the advertisement manager 120 based on the advertisement object code included in the first advertisement.

The advertisement manager 120 extracts the requested second advertisement from the advertisement database and transmits the extracted second advertisement to the advertisement processor 320 of the service receiver 300 in a web form at step S35. The advertisement processor 320 receives the second advertisement and provides it to the user through a user interface.

When a user makes an order of a predetermined service after watching the second advertisement, the order processor 360 transmits the order information to the order manager 160 of the local advertisement server 100 at step S40. The order manager 150 manages the requested order information through database and transmits it to the advertiser server 500 as order request information at step S50.

When the advertiser server 500 receives the order requested information, the advertiser server 500 requests billing information to the service receiver 300 at step S60. Herein, the billing information is required to process a billing operation related to providence of the requested service at step S65. The advertiser server 500 performs a billing process based on the provided billing information and provides the ordered service with the result of performing the billing information to the service receiver 300 at step S70.

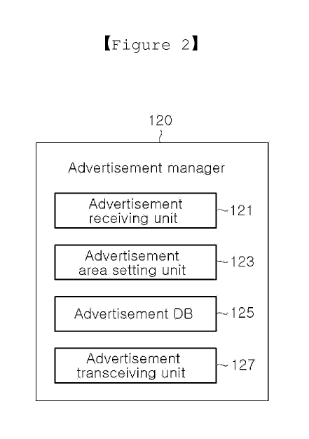

FIG. 2 is a block diagram illustrating an advertisement manager 120 of a local advertisement server 100 shown in FIG. 1.

As shown, the advertisement manager 120 of the local advertisement server 100 includes an advertisement receiving unit 121, a local area setting unit 123, an advertisement DB 125, and an advertisement transceiving unit 127.

The advertisement receiving unit 121 receives advertisement information requested to register from the advertiser server 500. The advertisement area setting unit 123 sets areas to provide advertisement information according to the request of the advertiser server 500. In the present embodiment, the advertisement area setting unit 123 creates advertisement identification (ID) including advertisement object code such as a national code, an area code, and an advertisement classification, corresponding to the advertisement area when the area to provide the advertisement is set.

The advertisement database DB 125 stores the advertisement information including the advertisement ID according to the set advertisement area in a form of a database.

The advertisement transceiver 127 transmits the registered advertisement information to the service receiver 300. In the present embodiment, the advertisement transceiver 127 transmits the first advertisement information among the advertisement information through multicasting, and transmits the second advertisement information to the service receiver 300 in a web form.

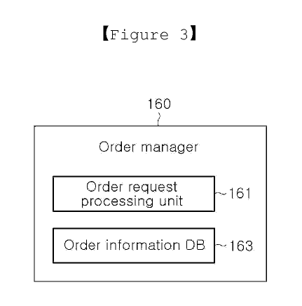

FIG. 3 is a block diagram illustrating an order manager 160 of a local advertisement server 100 shown in FIG. 1.

As shown in FIG. 3, the order manager 160 of the local advertisement server 100 includes an order request processing unit 161 and an order information DB 163.

The order request processing unit 161 transmits order information requested by the order from the service receiver 300 to the advertiser server 500.

The order information DB 163 stores and manages the requested order information from the service receiver 300 through database.

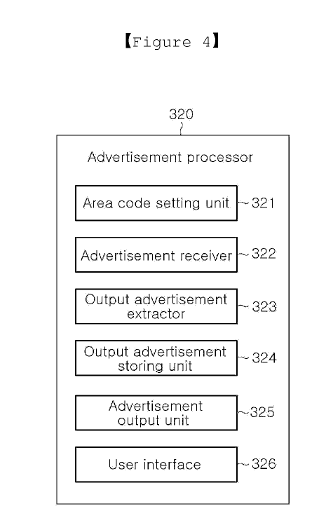

FIG. 4 is a block diagram illustrating an advertisement processor 320 of a service receiver 300 shown in FIG. 1.

Referring to FIG. 4, the advertisement processor 320 of the service receiver 300 includes an area code setting unit 321, an advertisement receiver 322, an output advertisement extractor 323, an output advertisement storing unit 324, an advertisement output unit 325, and a user interface 326.

The area code setting unit 321 sets and manages address identification (ID) information transmitted including own national code and area code through communicating with the local advertisement server 100.

The advertisement receiver 322 receives the first and second advertisement information transmitted from the local advertisement server 100.

The output advertisement extractor 323 extracts advertisement list that can be outputted corresponding to the set address identification ID from the received first advertisement.

The output advertisement storing unit 324 stores and manages the extracted advertisement information that is the first advertisement.

The advertisement output unit 325 outputs the stored advertisement information (first advertisement) in a subtitle form at a predetermined time interval through the user interface 326.

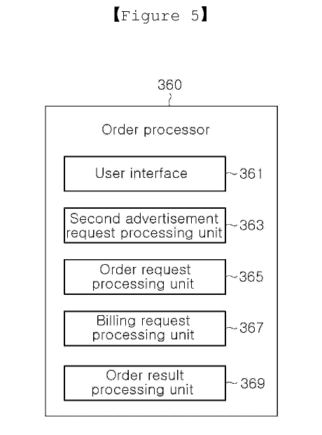

FIG. 5 is a block diagram illustrating an order processor 360 of a service receiver 300 shown in FIG. 1.

As shown, the order processor 360 of the service receiver 300 includes a user interface 361, a second advertisement request processing unit 363, an order request processing unit 365, a billing request processing unit 367, and an order result processing unit 369.

The user interface 361 is an interface for receiving a request of transmitting the second advertisement from user, and for receiving an order request instruction through the provided second advertisement information.

When the order of requesting the second advertisement inputs from a user through the user interface 361, the second advertisement request processing unit 363 transmits information for requesting the second advertisement corresponding to the selected first advertisement to the advertisement manager 120 of the local advertisement server 100.

When a user inputs an instruction of requesting an order corresponding to the second advertisement through the user interface 361, the order request processing unit 365 transmits the selected order request information to the order manager 160 of the local management server 100.

The billing request processing unit 367 provides billing information inputted through the user interface 361 from a user to the advertiser server 500 when the advertiser server 500 requests the billing information required for the billing process corresponding to the ordered service.

The order result processing unit 369 provides order result information including the billing process and the ordered service information from the advertiser server 500 to a user through the user interface 361.

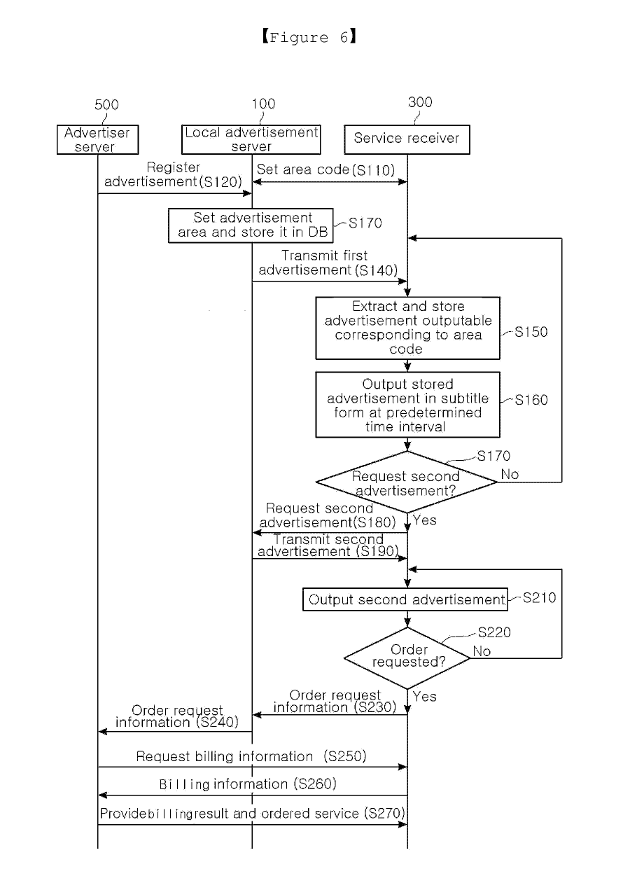

FIG. 6 is a flowchart illustrating a method of providing interactive local advertisement using multicast according to an embodiment of the present invention.

As shown, after a system boots up, the service receiver 300 accesses the local advertisement server 100 and sets the address identification ID including own area code at step S110. In more detail, the service receiver 300 accesses the local advertisement server 100 and requests the local advertisement server 100 to check whether a user ID and a currently stored address ID are matched or not. Then, the local advertisement server 100 compares previously registered user ID and address ID of subscriber information with the user ID and address ID transmitted from the service receiver 300. If they are not matched, the local advertisement server 100 transmits matched address ID to the service receiver 300 so as to enable the service receiver 300 to set and store the newly provided address ID.

Then, the advertiser server 500 accesses the local advertisement server 100 and registers advertisement information to provide to a target area at step S120. The local advertisement server 100 sets an advertisement ID including an advertisement area to provide registered and requested advertisement information and stores the set advertisement ID in a database at step S130. The local advertisement server 100 extracts first advertisement information from the stored advertisement information and transmits the extracted first advertisement information through multicast at step S140.

The service receiver 300 receives the first advertisement information multicasted from the local advertisement server 100, compares the advertisement ID included in the received first advertisement information with an address ID included in an area code set at the step S110, extracts the advertisement output corresponding to the set area and stores the extracted advertisement at step S150.

Afterward, the service receiver 300 outputs the stored first advertisement information on the display of the user interface 361 in a subtitle form at step S160. Herein, the service receiver 300 determines whether an instruction for requesting the second advertisement corresponding to the first advertisement inputs or not at step S170. If the service receiver 300 determines that the instruction for the second advertisement inputs, the service receiver 300 transmits the second advertisement request information to the local advertisement server 100 at step S180.

The local advertisement server 100 extracts the second advertisement information corresponding to the provided first advertisement from the advertisement database 125 in response to the request of providing the second advertisement and provides the extracted second advertisement information to the service receiver 300 at step S190. The service receiver 300 outputs the second advertisement provided from the local advertisement server 100 at step S210.

The service receiver 300 determines whether an instruction for requesting an order inputs or not based on the outputted second advertisement information at step S220. If the service receiver 300 determines that the instruction for requesting an order inputs, the service receiver 300 transmits order request information for receiving a service corresponding to the selected second advertisement information to the local advertisement server 100 at step S230.

The local advertisement server 100 stores and transmits order request information transmitted from the service receiver 300 to the advertiser server 500 at step S240.

The advertiser server 500 transmits a signal of requesting billing information for a billing process for providing order request information received from the local advertisement server 100 to the service receiver 300 at step S250.

After receiving the billing information request signal, the service receiver 300 transmits billing information to the advertiser server 500 at step S260.

The advertiser server 500 performs a billing process according to the billing information provided from the service receiver 300 and provides the requested service with the result thereof to the service receiver 300 at step S270.

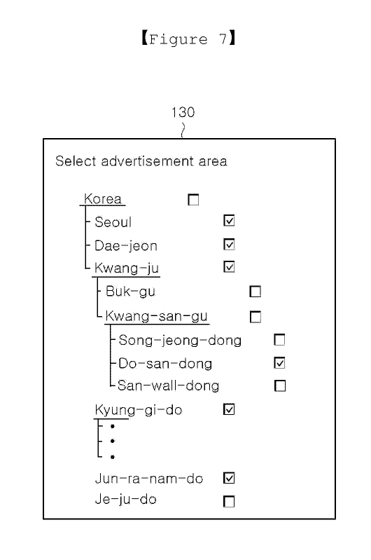

FIG. 7 is a view for non-hierarchically selecting areas to provide registered advertisement through an advertiser server 500 according to an embodiment of the present invention.

As shown, the advertiser server 500 can select areas to provide advertisement through an advertisement area selecting menu 130 provided from the local advertisement server while registering advertisement to provide.

For example, if “Korea” is selected, all of low level areas related thereto are selected. If “Kwangju city” is selected, all of low level areas related thereto are selected. As described above, a plurality of areas to provide advertisement and related services can be non-hierarchically selected through the advertiser server 500.

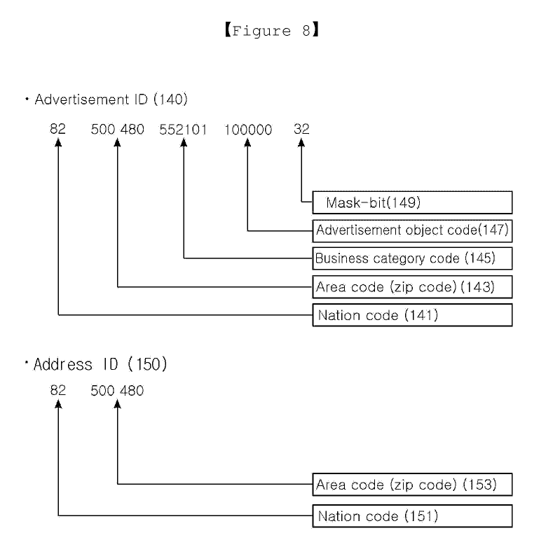

FIG. 8 is a view illustrating advertisement identification (ID) set by a local advertisement server 100 and address identification (ID) set by a service receiver 300 according to an embodiment of the present invention.

As shown, the advertisement ID set by the local advertisement server 100 includes a national code 141, an area code (zip code) 143, a business category code 145, an advertisement object code 147, and a mask-bit 149. Herein, if an advertiser non-hierarchically selects several advertisement areas through the advertiser server 500, advertisement IDs 140 are created as many as the number thereof.

The national code 141 and the area code 143 are codes created when an advertiser selects an advertisement area through the advertiser server 500.

The business category code 145 is a code for identifying a business category of an advertiser. The advertisement object code 147 is assigned by the advertisement manager 120 when an advertisement is registered through the advertiser server 500, and is a code for identifying the advertisements.

The mask bit 149 is a code use to extract an advertisement according to an area at the service receiver 300. When an advertiser selects an advertisement area through the advertiser server 500, the mask bit 149 is automatically created according to the national code 141 and the area code 143.

In FIG. 8, the address ID 150 set by the service receiver 300 includes a national code and an area code (zip code) 153.

The national code 151 and the area code 153 are information included in the address ID 150 that is set by the service receiver 300 through accessing the advertiser server.

The national code 151 and the area code 153 denote information about nations and areas to receive services through the service receiver 300.

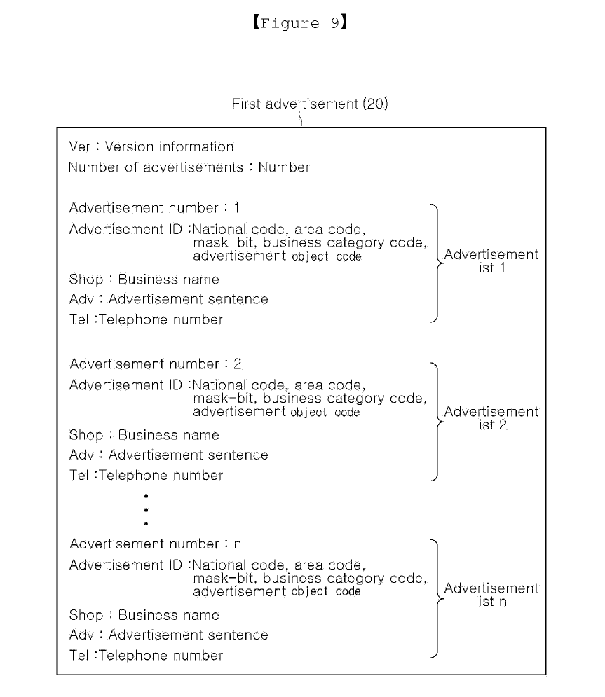

FIG. 9 is a view illustrating first advertisement contents transmitted through multicasting from a local advertisement server 100 shown in FIG. 1.

As shown, the first advertisement information 20 includes version information thereof, and the number of advertisements included in the first advertisement information.

The first advertisement information 20 includes an advertisement number, an advertisement ID, a business name, advertising sentences, and telephone number.

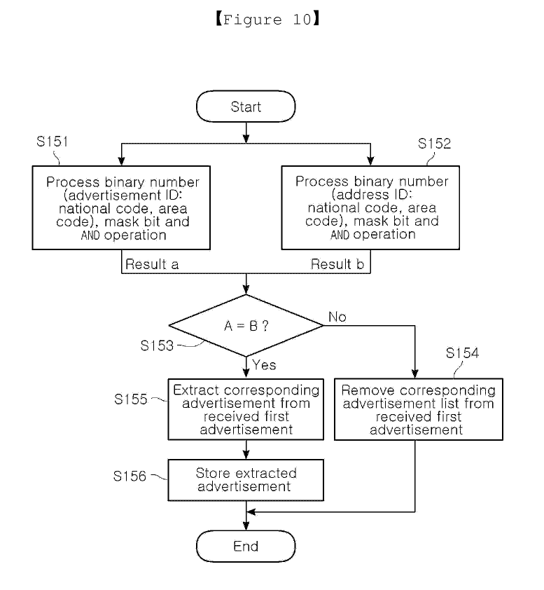

FIG. 10 is a flowchart illustrating the step S150 for extracting available advertisements to output based on the received advertisement in FIG. 6.

As shown in FIG. 10, the service receiver 300 extracts available advertisements to output by comparing advertisement ID extracted from the received first advertisement and the address ID of the service receiver 300 with the bit masking.

At first, the service receiver 300 transforms the national code 141 and the area code 143 from the advertisement ID 140 of the received advertisement information to a predetermined length of a binary number and performs an “AND” operation with the mask bit at step S151.

The service receiver 300 transforms the address ID 150 of the service receiver 500 to a predetermined length of a binary number and performs an “AND” operation with a mask-bit of the advertisement ID 140 at step S152.

The service receiver 300 determines whether the results A and B obtained from the step S151 and the step S152 are matched or not at step S153.

If they are not matched, the service receiver 300 removes corresponding advertisement list from the received first advertisement information at step S154.

If they are matched, the service receiver 300 extracts information included in a corresponding advertisement list from the received first advertisement at step S155. Herein, the service receiver 300 stores and manages the extracted first advertisement at step S156.

The service receiver 300 repeatedly performs the steps S151 to S156 for entire first advertisement information.

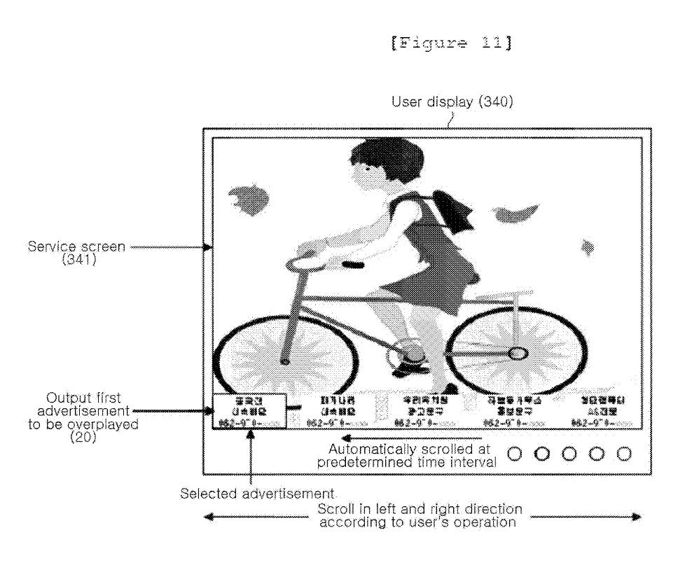

FIG. 11 is a view illustrating a display of a user interface with first advertisement information provided in a subtitle form according to an embodiment of the present invention.

As shown, the predetermined number of first advertisements 20 is overplayed on a service screen 341 of the user display 340 in the subtitle form, and they are automatically scrolled at a predetermined time interval. The first advertisement information 20 displayed according to the user s operation is scrolled in a left and right direction. If predetermined advertisement information is selected, a signal for requesting second advertisement information is transferred to the local advertisement server 100 based on an advertisement object code included in corresponding advertisement identification ID.

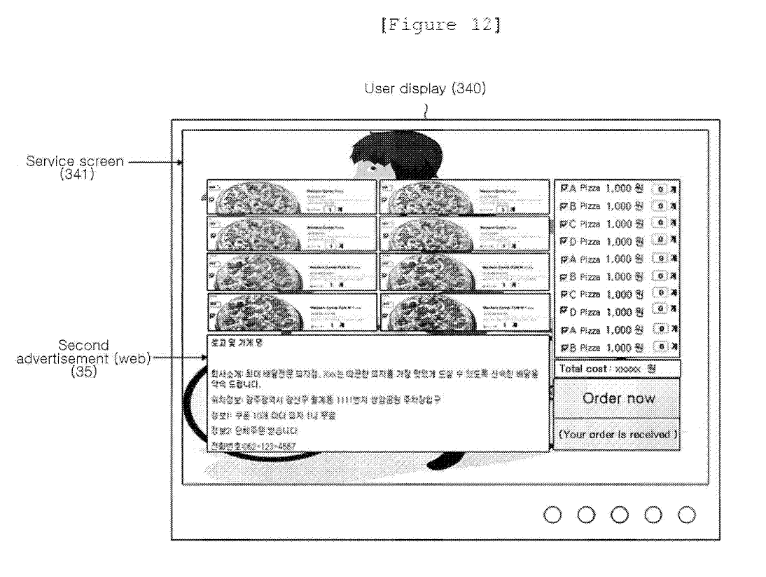

FIG. 12 is a view illustrating second advertisement information received from the local advertisement server 100 displayed on a user s display in a web form according to an embodiment of the present invention.

As shown, the second advertisement information 35 is overlaid on the screen 341 where a service is received and displayed on. Herein, the outputted second advertisement information 35 includes a menu for requesting an order a service related to corresponding advertisement information.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. An interactive advertisement system using multicast comprising:
an advertiser server for requesting registration of advertisement information by setting advertisement ID (identification) including areas to provide the advertisement information, and providing services in response to an order of available services corresponding to the advertisement information;
a local advertisement server for storing and registering the advertisement information including the advertisement ID corresponding to the registration request of the advertiser server, multicasting the registered advertisement information with the advertisement ID through an IP network, and transmitting information related to an order of requesting services corresponding to the advertisement information to the advertiser server if the services corresponding to the advertisement information are ordered; and
a service receiver for receiving the multicasted advertisement information, extracting advertisement information providing a corresponding service from the received advertisement information, and outputting the extracted advertisement information through a user interface, and for requesting the local advertisement server to order the input service if an order of a service corresponding to the outputted advertisement information inputs, and receiving the corresponding service from the advertiser server.

2. The interactive advertisement system using multicast according to claim 1, wherein the advertiser server requests the advertisement information to register to the local advertisement server by dividing the advertisement information by a detail level of information that describes the advertisement information.

3. The interactive advertisement system using multicast according to claim 2, wherein the advertiser server requests the advertisement information to register to the local advertisement server by dividing the advertisement information into first advertisement and second advertisement by detail level of information describing the advertisement information.

4. The interactive advertisement system using multicast according to claim 3, wherein the advertiser server sets non-hierarchically areas to provide the advertisement information.

5. The interactive advertisement system using multicast according to claim 1, wherein the advertisement ID includes a national code and an area code for providing the advertisement information, a business category code, an advertisement object code, and mask-bit information for the advertisement information.

6. The interactive advertisement system using multicast according to claim 3, wherein the local advertisement server registers and manages the advertisement with the advertisement ID by dividing the advertisement information into the first advertisement information and the second advertisement information, transmits the first advertisement information through multicasting, and transmits the second advertisement information as a web form to the service receiver if the second advertisement corresponding to the first advertisement is requested.

7. The interactive advertisement system using multicast according to claim 6, wherein a service related to the second advertisement information is ordered from the service receiver, the local advertisement server stores input order information and transmits the input order information to the advertiser server.

8. The interactive advertisement system using multicast according to claim 3, wherein the service receiver sets an address ID (identification) including a national code and a local code for receiving a corresponding service by accessing the local advertisement server, and
wherein the service receiver receives the multicasted first advertisement information, and extracts advertisement information providing a corresponding service from the received first advertisement information by comparing the advertisement ID included in the received first advertisement information and the address ID of the service receiver.

9. The interactive advertisement system using multicast according to claim 8, wherein the service receiver outputs advertisement information extracted from the first advertisement information on the user interface as a subtitle form at a predetermined time interval.

10. The interactive advertisement system using multicast according to claim 8, wherein the service receiver transforms a national code and an area code in the advertisement ID of the received first advertisement information to a predetermined length of a binary number, obtains a result A by performing an “AND” operation with a mask-bit, transforms an address ID of the service receiver into a predetermined length of a binary number, obtains a result B by performing an “AND” operation with the mask-bit of the advertisement ID, and extracts advertisement information providing a corresponding service from the first advertisement information by comparing the results A and B.

11. The interactive advertisement system using multicast according to claim 9, wherein the service receiver request second advertisement information set corresponding to the first advertisement information to the local advertisement server based on advertisement object code information included in the advertisement ID in the first advertisement information.

12. A method for interactive advertising using multicast comprising:
at a local advertisement server, setting an advertisement ID (identification) including areas to provide advertisement information, and storing and registering the advertisement information including the advertisement ID in response to a registration request when registration of the advertisement information is required;
at the local advertisement server, multicasting the registered advertisement information with the advertisement ID;
at a service receiver, receiving the multicasted advertisement information, extracting advertisement information providing a corresponding service from the received advertisement information, and outputting the extracted advertisement information through a user interface; and
at the service receiver, requesting a service to order when an order of the service corresponding to the outputted advertisement information inputs, and receiving a corresponding thereof.

13. The method according to claim 12, wherein registering the advertisement information includes:
at the local advertisement server, non-hierarchically setting areas to provide the advertisement according to a request instruction; and
registering the advertisement information by dividing the advertisement information into first advertisement information and second advertisement information according to a detail level of information describing the advertisement information according to requested instruction.

14. The method according to claim 12, wherein the advertisement ID includes a national code and an area code to provide the advertisement information, a business category code, an advertisement object code, and mask-bit information for the advertisement information.

15. The method according to claim 14, wherein the step of multicasting the registered advertisement information includes:
multicasting the first advertisement information of the advertisement information through an IP network; and
transmitting second advertisement information in a web type to the service receiver when the second advertisement information corresponding to the first advertisement information.

16. The method according to claim 15, wherein, at the service receiver, setting an address ID (identification) including a national code and an area code to provide a corresponding service by accessing the local advertisement server;
receiving the multicasted first advertisement information, and extracting advertisement information providing a corresponding service from the received first advertisement information by comparing an advertisement ID included in the first advertisement information and an address ID of the service receiver;
outputting the extracted advertisement information from the first advertisement information at a predetermined time interval in a subtitle type;
requesting second advertisement information to the local advertisement server if the second advertisement information corresponding to the outputted first advertisement information; and
receiving the requested second advertisement information and outputting the received second advertisement information through the user interface.

17. The method according to claim 16, wherein the step of extracting the advertisement information includes:
transforming a national code and an area code of the advertisement ID of the received first advertisement information to a predetermined length of a binary number, and obtaining a result A by performing an “AND” operation with a mask-bit;
transforming an address ID of the service receiver into a predetermined length of a binary number, and obtaining a result B by performing an “AND” operation with the mask-bit of the advertisement ID;
comparing the result A and the result B whether the results A and B are matched or not; and
extracting advertisement information providing a corresponding service from the received first advertisement information if the result A is matched with the result B.

18. A local advertisement server comprising:
an advertisement manager for registering and managing advertisement information including an advertisement ID (identification) which is required to register by an advertiser server that provides advertisement information and a service corresponding the advertisement information, and multicasting the advertisement information including the advertisement ID through an IP network; and
a local advertisement server for managing order information requested in correspondence with the multicasted advertisement information and transmitting the order information to an advertiser server corresponding to the advertisement information.

19. The local advertisement server according to claim 18, wherein the advertisement manager includes:
an advertisement receiving unit for receiving advertisement information requested to register by the advertiser server by dividing the advertisement information into first and second advertisement information according to detail level of the advertisement information;
an advertisement area setting unit for setting advertisement ID (identification) including areas to provide the advertisement information according to a request of the advertiser server;
an advertisement DB (database) for storing the advertisement information by building a database with the advertisement information with the advertisement ID set; and
an advertisement transceiving unit for multicasting the stored advertisement information.

20. The local advertisement server according to claim 19, wherein the advertisement ID includes a national code and an area code to provide the advertisement information, and a business category code, an advertisement object code, and mask-bit information for the advertisement information.

21. A local advertisement service receiver comprising:
an advertisement processor for receiving advertisement information including advertisement ID (identification), comparing the received advertisement information with previously set address ID, extracting advertisement information suitable to a corresponding area from the received advertisement information based on the comparison result, and outputting the extracted advertisement information through a user interface; and
an order processor for transmitting information related to an order of a service corresponding to the outputted advertisement information when the order of the service inputs, and receiving a corresponding service from an advertisement server that provides a service corresponding to the advertisement information.

22. The local advertisement service receiver according to claim 21, wherein the advertisement processor includes:
an area code setting unit for setting address ID (identification) including an national code and an area code through communication with a local advertisement server that transmits the advertisement information;
an advertisement receiving unit for receiving first and second advertisement information which are divided according to detail level of the advertisement information transmitted from the local advertisement server;
an output advertisement extractor for extracting advertisement information that can be outputted corresponding to the address ID set in the received first advertisement information;
an output advertisement storing unit for storing and managing the extracted first advertisement information; and
an advertisement outputting unit for outputting the stored first advertisement information in a subtitle form at a predetermined time interval through a user interface.

23. The local advertisement service receiver according to claim 22, wherein the order processor includes:
a user interface for outputting the first and second advertisement information to a user;
a second advertisement request processor for transmitting a request of transmitting second advertisement corresponding to selected first advertisement to the local advertiser server when an instruction of requesting the second advertisement inputs from a user through the user interface;
an order request processor for transmitting selected order request information to the local advertisement management server when an instruction of requesting an order corresponding to second advertisement from a user through the user interface;
a billing request processor for providing billing information inputted through the user interface to the advertiser server when the advertiser server requests billing information required for a billing process corresponding to the order request information; and
an order result processor for providing order result information including a result of performing a billing process and ordered service information from the advertiser server to the user through the user interface.
